(19) United States
(12) Patent Application Publication
(10) Pub. No.: US 2018/0040248 A1
(43) Pub. Date: Feb. 8, 2018

(54) Anti-Collision, Accident Prevention Car Safety Systems to Provide Visibility when Passing, Pulling or Backing out of Parking Spaces/Driveways and Entering or Crossing Intersections

(71) Applicant: Herman L. Bigham, Philadelphia, PA (US)

(72) Inventor: Herman L. Bigham, Philadelphia, PA (US)

(21) Appl. No.: 15/669,248

(22) Filed: Aug. 4, 2017

Related U.S. Application Data
(60) Provisional application No. 62/370,751, filed on Aug. 4, 2016.
(60) Provisional application No. 62/393,248, filed on Sep. 12, 2016.

(51) Int. Cl. G08G 1/16; G03B 17/08; G06K 9/00; H04N 5/247; B60R 1/00; B60R 1/12

(52) U.S. Cl. CPC G08G 1/166; B60R 1/00; B60R 1/12; G06K 9/00805; H04N 5/247; G03B 17/08; B60R 2001/1253; B60R 2300/105; B60R 2300/20; B60R 2300/301; B60R 2300/406; B60R 2300/8066; B60R 2300/8093; B60K 2350/1012; B60K 2350/106; B60K 2350/1088; B60K 2350/2013; B60K 2350/927; B60K 2350/965

(57) ABSTRACT

A vehicle safety system that provides a clear view of blind spots, approaching motor vehicles in oncoming and peripheral lanes when attempting to pass on a two-lane highway consists of a pair of side mirror-mounted cameras, a split viewing screen/monitor, a plurality of controls, and a microcontroller. The visual data received from the pair of side mirror-mounted cameras is displayed on the split viewing screen/monitor. Thus, the user can view oncoming motor vehicles. Preferably, the split viewing screen/monitor is mounted adjacent to a rear-view mirror of a motor vehicle. The plurality of controls allows the user to control the content displayed on the split viewing screen/monitor. When front-facing cameras and rear-facing cameras are available, the user is provided with information regarding obstacles surrounding the motor vehicle. The pair of front-facing cameras and the pair of rear-facing cameras are especially beneficial when backing out of parking spaces and driving through intersections.

The current application claims a priority to the U.S. Provisional Patent application Ser. No. 62/370,751 filed on Aug. 4, 2016 and a priority to the U.S. Provisional Patent application Ser. No. 62/393,248 filed on Sep. 12, 2016.

### FIELD OF THE INVENTION

The present invention relates generally to safety system that provides a clear view of blind spots, approaching motor vehicles in oncoming and peripheral lanes when attempting to pass on a two-lane highway. Moreover, the present invention is beneficial when pulling or backing out of parking spaces, driveways and entering or driving through intersections.

### BACKGROUND OF THE INVENTION

With developments in technology, the number of safety features available in motor vehicles have also risen. Reverse cameras, automatic braking systems, and lane change assist systems are some of the significant features that are provided in modern motor vehicles.

The newest approaches in driver safety mainly focus on collision avoidance, mitigating and warning systems that help reduce the severity of a collision. Moreover, many of the safety systems warn the driver regarding a potential collision or act autonomously to prevent the collision and provide visibility directly in front of the motor vehicle or directly behind the motor vehicle. Having a view behind the motor vehicle helps when reversing the motor vehicle. In some instances, the safety system may notify the driver of an oncoming vehicle. However, these systems are not designed to allow the driver to view approaching vehicles when passing in oncoming lanes or peripheral lanes. A majority of these safety systems are not connected to a live streaming screen and are not intended to provide visibility of approaching vehicles when pulling out of parking spaces/driveways and when driving through intersections. The present invention, let Pass', provides the driver with a clear view of blind zones and approaching vehicles normally obstructed by parked cars. Moreover, a majority of the camera systems are dashboard mounted cameras that provide security by recording the activity around the front of the car for playback. Thus, dashboard mounted cameras do not provide any accident prevention value.

Most rural, country roads and highways in underdeveloped countries are one lane in each direction and share passing lanes. These roads are highly traveled by all types of vehicles which are often unlighted or poorly lighted. Attempting to pass trucks and other slower moving vehicles are constant hazard. The passing maneuver on two-lane highways is one of the most demanding and hazardous operations performed by motorists every day.

High speed head on road crashes accrue more frequently when passing on one lane roads that on any other road configuration. Passing on one lane roads causes more vehicular death that any other maneuver. Its danger lies in the fact that a passing vehicle must occupy an opposing lane of traffic to complete the maneuver. This is a global road safety problem caused principal by the lack of visibility of same lane and oncoming vehicles when attempting to pass. Two-lane highways comprise the majority of the roadway mileage in the United States.

85% of the documented road accidents on Kenyan roads are caused by human error. In Kenya Untold accidents, injuries & fatalities are caused annually by vehicles attempting to pass. These figures are doffed by the everyday “Near Miss”.

Sudden crossing of lanes to overtake another vehicle is the major cause of accidents“, said Colonel Hamad Adil Al Shamsi, the Director of the Department of Traffic and patrol police. Published: 18:42 Mar. 6, 2008 Gulf News Rayeesa Absal, Staff Reporter: Abu Dhabi: Wrong overtaking has proved to be one of the main causes of fatal traffic accidents said traffic officials. In 2007, at least 233 deaths and 93 accidents were recorded in the country because of wrong overtaking and 19,458 traffic fines were issued for this offence alone.

According to the 2009 World Health Organization (WHO) global status report, Kenya recorded 3,760 traffic deaths, the highest in East Africa region. At least 90% of the global fatalities from traffic accidents occur in low and middle-income countries even though, only 46% of global vehicles are in these countries. Kenya has among the worst statistics globally (WHO Global status report, 2009). By 2015, WHO predicts the increase of road deaths to rise from 1.2 to 1.8 million, and 2.4 million by 2030. About 1.25 million people die each year as a result of road traffic crashes. Road traffic injuries are the leading cause of death among young people, aged 15-29 years.

When considering motor vehicle related fatalities, the highest number of fatalities are caused from head-on collisions. These types of collisions are most commonly seen when only one lane is used for traffic in each direction. In these instances, when one motor vehicle needs to pass another motor vehicle travelling in the same direction, the adjacent traffic lane with traffic in the opposite direction needs to be used. If not executed properly, the process of using the adjacent lane with opposing traffic can result in unfavorable results. The risk involved with such a process exponentially grows if the road is curved at the point of passing. Thus, a safety feature that can display oncoming traffic is essential to prevent future head-on collisions. The present invention provides a clear view around slow moving vehicles obstructing the view of the driver. The present invention allows the driver to see oncoming and peripheral lanes when attempting to pass.

With the rise in the number of motor vehicles on the road, parking has turned out to be a significant issue. Street parking and parking lots with minimum space utilization have addressed the issue to some extent. Moreover, studies have shown that the most frequent and critical reason for intersection related crashes is inadequate surveillance (44.1%) and turning with an obstructed view. With the rising number of motor vehicles, a method for providing visibility when pulling out of a parking space, a driveway, or driving through an intersection is clearly required. The front bumper mounted cameras provide the driver a clear view before entering an intersection or pulling out of a parking space. The front cameras also provide a view of oncoming vehicles blocked by parked cars.

The prior art, U.S. Pat. No. 9,227,575 B2, discusses cameras mounted onto the side mirrors. However, the prior art only focuses on locating objects close the side mirrors and can potentially damage the side mirrors. The prior art describes a system that retracts the pair of side mirrors based on the data received by the cameras. The cameras mentioned in the prior art are not connected to a viewing screen and are not intended to provide the driver with a view of oncoming vehicles.

The objective of the present invention is to address the aforementioned issues. In particular, the present invention will provide additional critical visibility not provided by other systems regarding oncoming motor vehicles, blind spots and when driving through intersections, or backing out from parking spaces/driveways. By utilizing the present invention, the user is guaranteed to have a clear view promoting safety when passing, pulling or backing out of parking spaces/driveways, and driving through intersections. More specifically, the present invention is designed to focus on eliminating daily road hazards and minimizing accidents and can be used on new and existing motor vehicles.

### BRIEF DESCRIPTION OF THE DRAWINGS

FIG. 1 is a block diagram illustrating the present invention.

FIG. 2A is another block diagram illustrating the present invention, wherein a wireless transceiver is used.

FIG. 2B is another block diagram illustrating the present invention, wherein a lighting source is used with the pair of rear-facing cameras.

FIG. 3 is an illustration of the present invention being used on a motor vehicle.

FIG. 4 is an illustration of the split viewing screen/monitor, wherein the rearview mirror is utilized as the split viewing screen/monitor.

FIG. 5 is a block diagram of the present invention, wherein a proximity sensor is used with the pair of side mirror-mounted cameras.

FIG. 6 is a block diagram of the present invention, wherein the present invention is powered through an external rechargeable battery unit.

### DETAIL DESCRIPTIONS OF THE INVENTION

All illustrations of the drawings are for the purpose of describing selected versions of the present invention and are not intended to limit the scope of the present invention. The present invention introduces a safety feature that can be used on new motor vehicles and older motor vehicles with great effectivity. More specifically, the present invention is a system that provides critical visibility of blind spots to a driver of a motor vehicle. In other words, the present invention provides visibility of approaching motor vehicles in oncoming and peripheral lanes when attempting to pass. By utilizing the present invention, the user is guaranteed to have a clear view promoting safety when passing, pulling or backing out from parking spaces/driveways and entering/driving through intersections.

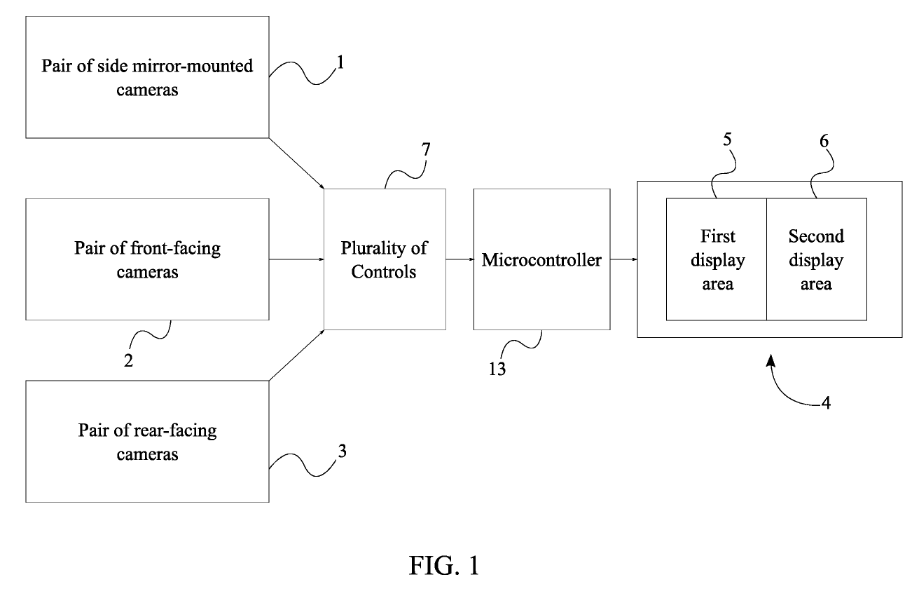

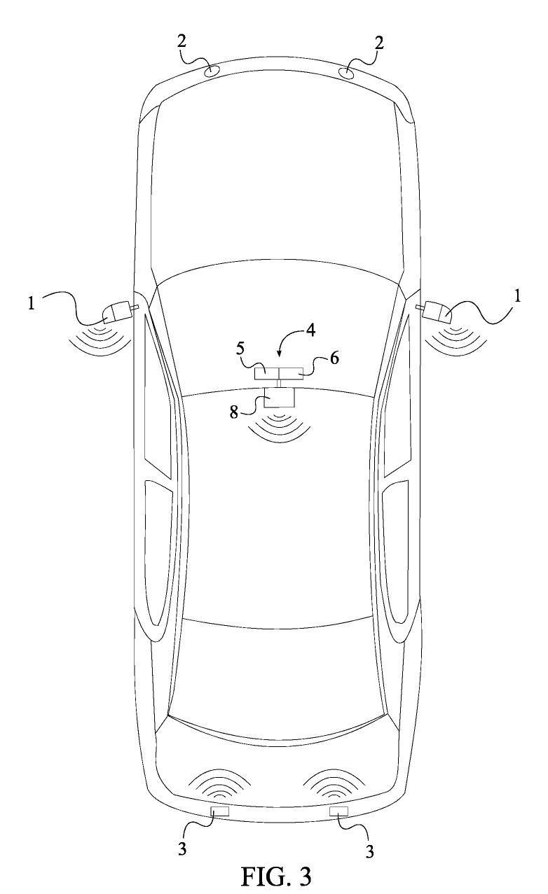

As seen in FIGS. 1-3, the present invention comprises a pair of side mirror-mounted cameras 1, a split viewing screen/monitor 4, a plurality of controls 7, and a microcontroller 13. The pair of side mirror-mounted cameras 1, oriented in a forward direction, is used to for viewing oncoming and peripheral lane traffic when attempting to pass. To do so, a first camera of the pair of side mirror-mounted cameras 1 is mounted onto the left-side mirror. Similarly, a second camera of the pair of side mirror-mounted cameras 1 is mounted onto the right-side mirror as seen in FIG. 3. The camera adjacent to the driving side, which is a narrow-focused camera, provides a clear view of the vehicles in front of the user. On the other hand, the camera adjacent to the passenger side, which is also a narrow-focused camera, provides a clear view of oncoming vehicles in an adjacent lane to the passenger and is especially useful on curved roads. The pair of side mirror-mounted cameras 1 can be fixed or removably attached to the side mirrors of the motor vehicle according to user preference. Being removably attached to the side mirror is important so that the pair of side mirror-mounted 1 cameras can be adjusted to enhance the view of oncoming motor vehicles. The view provided by the pair of side mirror-mounted cameras 1 is displayed on the split viewing screen/monitor 4 so that the user can view obstacles or other vehicles blocking the view. The split viewing screen/monitor 4 can be positioned over or adjacent to an existing rearview mirror or solely utilized instead of the rearview mirror. The plurality of controls 7 allows the user to alternate between different views. Preferably, each of the plurality of controls 7 will be a push button so that the user can conveniently control each of the plurality of controls 7 while driving. Preferably, the plurality of controls 7 is positioned adjacent the split viewing screen/monitor 4 to provide user convenience. However, the plurality of controls 7 can be positioned differently in other embodiments of the present invention. The microcontroller 13 ensures that all electronic functionalities of the present invention are appropriately executed. As an example, functionalities such as displaying visual data as seen by the pair of side mirror-mounted cameras 1 on the split viewing screen/monitor 4, switching between views, and executing electronic functions as determined by the plurality of controls 7 are controlled with the microcontroller 13.

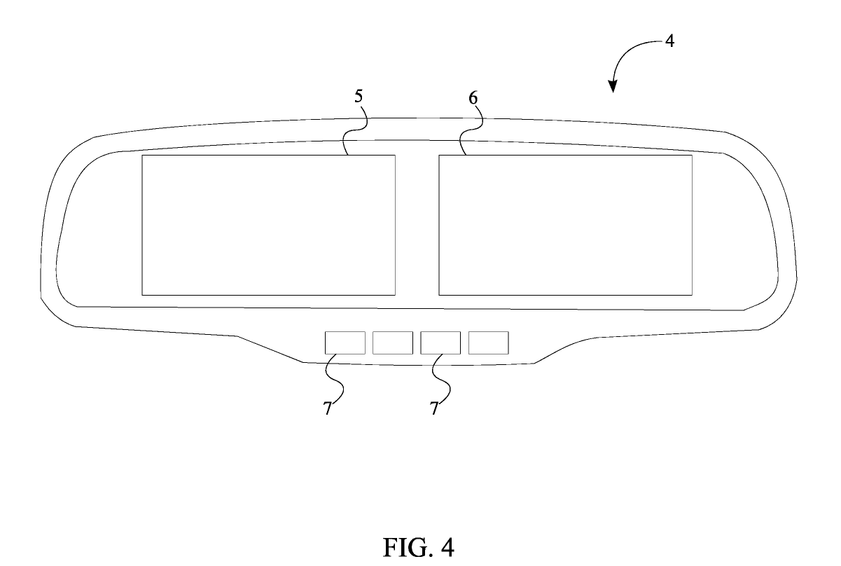

As seen in FIG. 3 and FIG. 4, to alternate between views from each of the pair of side mirror-mounted cameras 1, the split viewing screen/monitor 4, comprises a first display area 5 and a second display area 6. Preferably, the split viewing screen/monitor 4 is a liquid crystal display (LCD) screen. The first display area 5 is positioned adjacent the second display area 6 so that the user can simultaneously view oncoming motor vehicles and surroundings as seen by the pair of side mirror-mounted cameras 1. As an example, visual data from the camera mounted on the left side-mirror will be displayed on the first display area 5. On the other hand, visual data from the camera mounted on the right side-mirror will be displayed on the second display area 6. Preferably, the split viewing screen/monitor 4 will have a height of 4-inches and a width of 6-inches. However, the size and shape of the split viewing screen/monitor 4 can change in different embodiments of the present invention. When a display panel is available on the dashboard of the car, as seen in most modern motor vehicles, the electrical wiring of the display panel can be adjusted so that the display panel functions as the split viewing screen/monitor 4. To transfer visual data, each of the pair of side mirror-mounted cameras 1 is electronically connected to the split viewing screen/monitor 4 through the microcontroller 13. To control the pair of side mirror-mounted cameras 1 and the visual data, the plurality of controls 7 is electronically connected to the microcontroller 13.

As further illustrated in FIG. 1 and FIG. 3, in addition to the pair of side mirror-mounted cameras 1, the present invention further comprises a pair of front-facing cameras 2 that help the user have better visibility of the obstacles in front of the motor vehicle. Preferably, the pair of front-facing cameras 2 is mounted onto the front bumper of the motor vehicle. To transfer visual data, the pair of front-facing cameras 2 is electronically connected to the split viewing screen/monitor 4 through the microcontroller 13. By utilizing the plurality of controls 7, the user can switch between the view from the pair of side mirror-mounted cameras 1 and the view from the pair of front-facing cameras 2.

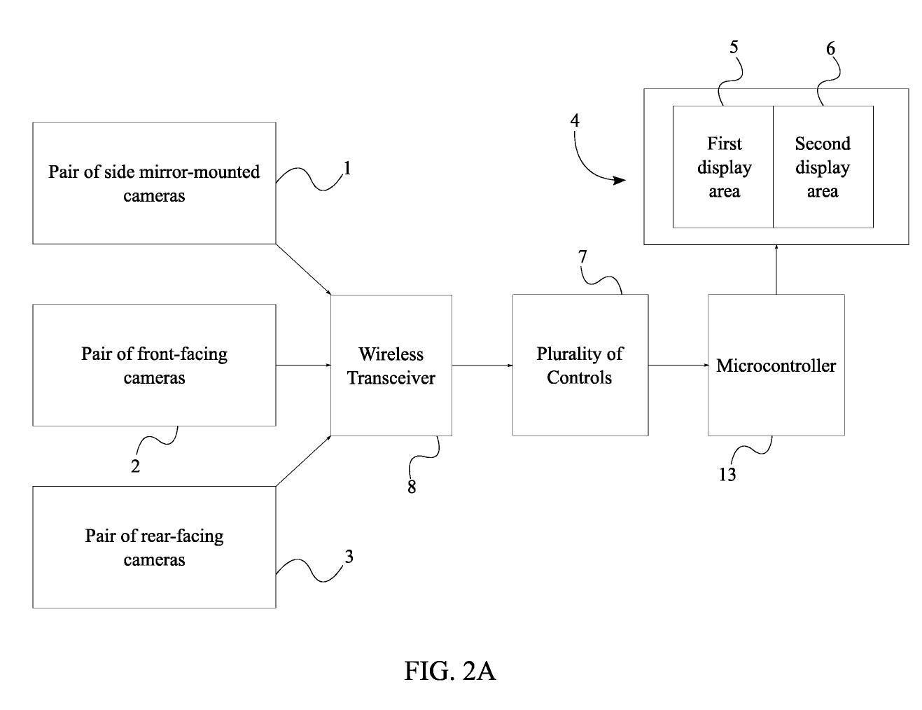

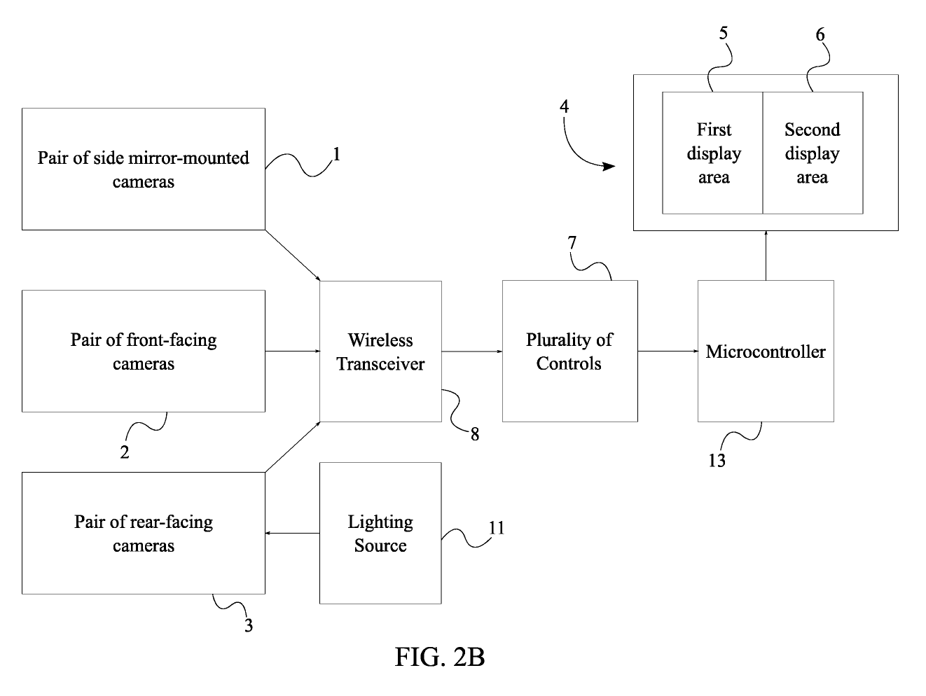

For added convenience, the present invention further comprises a pair of rear-facing cameras 3. Similar to the pair of front-facing cameras 2, the pair of rear-facing cameras 3 is also electronically connected to the split viewing screen/monitor 4 through the microcontroller 13 and is preferably mounted onto the rear bumper of the motor vehicle. With the use of the plurality of controls 7, the user can alternate between visual data received from the pair of side mirror-mounted cameras 1, the pair of front-facing cameras 2, and the pair of rear-facing cameras 3. As shown in FIG. 2B, the present invention further comprises a lighting source 11 which is used along with the pair of rear-facing cameras 3 during low-visibility conditions. To do so, the lighting source 11 is positioned adjacent each of the pair of rear-facing cameras 3. The lighting source 11 can be, but is not limited to, a plurality of light-emitting diodes (LEDs).

The pair of side mirror-mounted cameras 1 can be electronically connected to the split viewing screen/monitor 4 differently in varying embodiments of the present invention. As an example, in one embodiment of the present invention, the pair of side mirror-mounted mirrors can be wired to the split viewing screen/monitor 4. As an example, when the pair of rear-facing cameras 3 is available with the pair of side mirror-mounted cameras 1, the first display area 5 will receive connectivity wires from each of the pair of side mirror-mounted cameras 1. On the other hand, the second display area 6 will receive connectivity wires from each of the pair of rear-facing cameras 3. Moreover, there will also be a connectivity wire to trigger the split viewing screen/monitor 4 when the motor vehicle is in reverse-mode.

In another embodiment of the present invention, the pair of side mirror-mounted cameras 1, the pair of front-facing cameras 2 or the pair of rear-facing cameras 3 can be wirelessly connected to the split viewing screen/monitor 4 through the microcontroller 13. In the preferred embodiment of the present invention, the pair of rear-facing cameras 3 is wirelessly connected to the split viewing screen/monitor 4. To do so, the present invention further comprises a wireless transceiver 8 so that each of the pair of rear-facing cameras 3 is communicably coupled with the wireless transceiver 8. To transfer data to the split viewing screen/monitor 4, the wireless transceiver 8 is communicably coupled with the split viewing screen/monitor 4 through the microcontroller 13. Therefore, the visual data from the pair of rear-facing cameras 3 is wirelessly transferred over to the split viewing screen/monitor 4 eliminating the need to wire the pair of rear-facing cameras 3 and the split viewing screen/monitor 4. The wireless transceiver 8 reduces interference, maximizes efficiency, and eliminates the need to disassemble components for wiring. To efficiently transfer images to the split viewing screen/monitor 4, each of the pair of side mirror-mounted cameras 1, each of the pair of front-facing cameras 2, and each of the pair of rear-facing cameras will consist of a wireless video processing unit. Even though only the pair of rear-facing cameras 3 is wirelessly connected to the split viewing screen/monitor 4 in the preferred embodiment, the pair of side mirror-mounted cameras 1 and the pair of front-facing cameras 2 can also be wirelessly connected to the split viewing screen/monitor 4 in other embodiments of the present invention.

When the wireless transceiver 8 is used with the pair of rear-facing cameras 3, the following process is generally followed. A left camera of the pair of rear-facing cameras 3 draws power from the tail light and transfers visual data to the split viewing screen/monitor 4 via the wireless transceiver 8. As a result, a left rear image from the left camera is displayed on the first display area 5 of the split viewing screen/monitor 4. Similarly, a right camera of the pair of rear-facing cameras 3 draws power from the tail light and transfers visual data to the split viewing screen/monitor 4 via the wireless transceiver 8. Thus, a right rear image from the right camera is displayed on the second display area 6 of the split viewing screen/monitor 4. When the motor vehicle the present invention is being used is moving forward, the first display area 5 will display images received from a left camera of the pair of side mirror-mounted cameras 1. On the other hand, the second display area 6 will display images received from a right camera of the pair of side mirror-mounted cameras 1. If the user intends on alternating between views, the plurality of controls 7 is used.

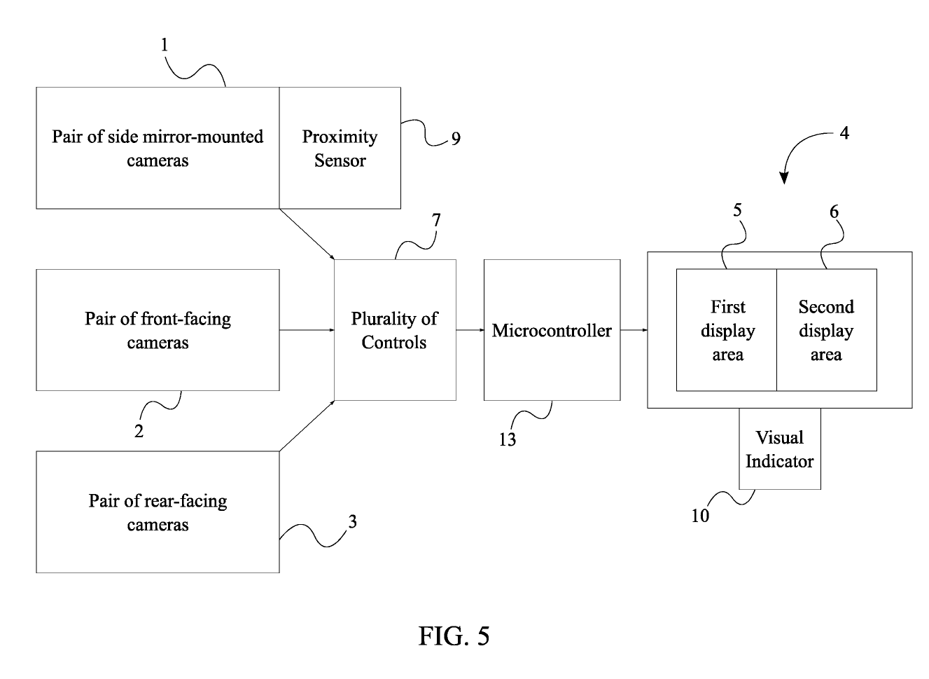

The present invention can further be enhanced to issue a warning regarding oncoming traffic. As illustrated in FIG. 5, the present invention further comprises a proximity sensor 9 and a visual indicator 10. The proximity sensor 9 determines the distance to an oncoming motor vehicle from a current location of the user, speed of oncoming vehicles, and the speed of the motor vehicle of the user and alerts the user via the visual indicator 10. More specifically, the proximity sensor 9 and the visual indicator 10 provides the user with a safe passing time and distance. To determine the distance to an oncoming motor vehicle, the proximity sensor 9 is integrated into each of the pair of side mirror-mounted cameras 1. However, the proximity sensor 9 can be connected to the pair of side mirror-mounted cameras 1 differently in other embodiments of the present invention. To transfer the relevant information, the proximity sensor 9 is communicably coupled with the visual indicator 10 through the microcontroller 13. To be promptly seen, the visual indicator 10 is preferably mounted onto the split viewing screen/monitor 4. The positioning allows the user to view the visual indicator 10, the first display area 5, and/or the second display area 6 simultaneously. In a default setting of the present invention, the visual indicator 10 will illuminate as a flashing green light to indicate the driver that passing a vehicle is safe. When the visual indicator is not functioning, or passing a vehicle is unsafe, the visual indicator 10 will illuminate in red.

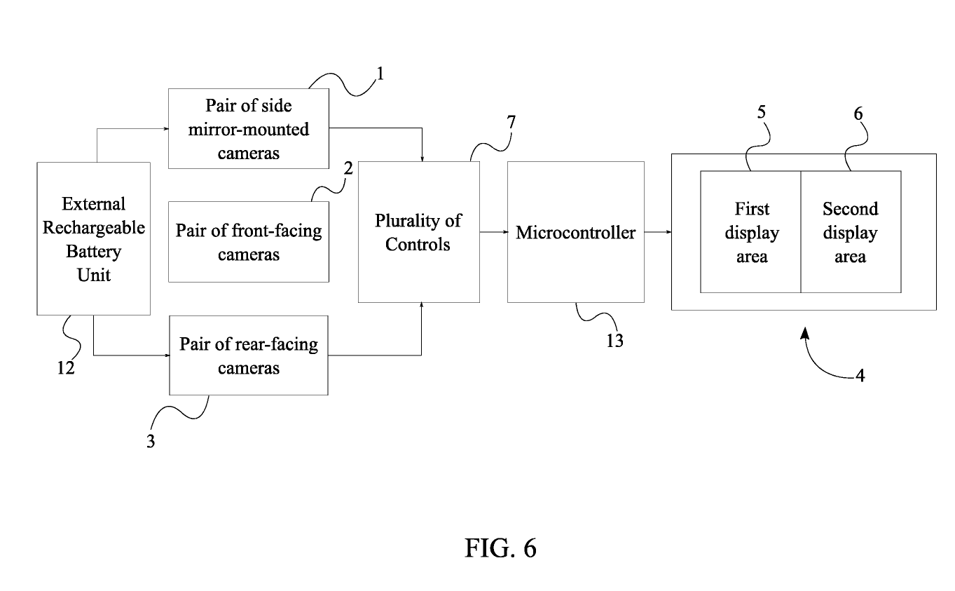

The present invention can be powered differently in varying embodiments of the present invention. Preferably, the present invention is powered through the internal battery of the motor vehicle. However, as illustrated in FIG. 6, in another embodiment, the present invention can further comprise an external rechargeable battery unit 12 that is electrically connected to the pair of side mirror-mounted cameras 1, the microcontroller 13, and the split viewing screen/monitor 4. The external rechargeable battery unit 12 is especially beneficial when the present invention is being used on an existing motor vehicle.

To withstand varying weather conditions and external forces, the pair of side mirror-mounted cameras 1 is designed to be waterproof and shockproof. Moreover, the pair of side mirror-mounted cameras will have a viewing range of approximately 2000-feet and be able to adjust according to external light and lights from other motor vehicles. When available, the pair of front-facing cameras 2 and the pair of rear-facing cameras 3 will also be waterproof and shockproof.

When the present invention is in use, the following process flow is generally followed. If the present invention is used with a new car, the microcontroller 13 is electronically connected to the control system of the motor vehicle. In such instances, the present invention is powered through the internal battery of the motor vehicle. Thus, when the motor vehicle is turned on and put in driving mode, the pair of side mirror-mounted cameras 1 also turn on. The visual data received from the pair of side mirror-mounted cameras 1 is transferred to the split viewing screen/monitor 4. When available and required, the user switches between the pair of side mirror-mounted cameras 1, the pair of front-facing cameras 2, and the pair of rear-facing cameras 3 as preferred with the use of the plurality of controls 7. As an example, if the user intends on reversing the motor vehicle, the user utilizes the plurality of controls 7 so that the visual images from the pair of rear-facing cameras 3 are displayed on the split viewing screen/monitor 4.

When the user intends on passing a motor vehicle, the visual images from the pair of side mirror-mounted cameras 1 and the data received by the proximity sensor 9 are processed and the visual indicator 10 is illuminated accordingly. As an example, if the proximity sensor 9 does not detect an oncoming motor vehicle, and passing another vehicle is safe, the visual indicator 10 will be a flashing green. Depending on the notification, the user can determine if passing another vehicle is safe or unsafe.

Although the invention has been explained in relation to its preferred embodiment, it is to be understood that many other possible modifications and variations can be made without departing from the spirit and scope of the invention as hereinafter claimed.

What is claimed is:

1. A system for providing visibility of oncoming vehicles and surrounding obstacles when passing, backing out of parking spaces/driveways, and entering/driving through intersections comprises:
a pair of side mirror-mounted cameras;
a split viewing screen/monitor;
a plurality of controls;
a microcontroller;
the split viewing screen/monitor comprises a first display area and a second display area;
the first display area being positioned adjacent the second display area;
each of the pair of side mirror-mounted cameras being electronically connected to the split viewing screen/monitor through the microcontroller;
the plurality of controls being electronically connected to the microcontroller; and
the plurality of controls being positioned adjacent the split viewing screen/monitor.

2. The system for providing visibility of oncoming vehicles and surrounding obstacles when passing, backing out of parking spaces/driveways, and entering/driving through intersections as claimed in claim 1 further comprises:
a pair of front-facing cameras; and
the pair of front-facing cameras being electronically connected to the split viewing screen/monitor through the microcontroller, wherein each of the pair of front-facing cameras is mounted onto a front bumper of a motor vehicle.

3. The system for providing visibility of oncoming vehicles and surrounding obstacles when passing, backing out of parking spaces/driveways, and entering/driving through intersections as claimed in claim 1 further comprises:
a pair of rear-facing cameras; and
the pair of rear-facing cameras being electronically connected to the split viewing screen/monitor through the microcontroller, wherein each of the pair of rear-facing cameras is mounted onto a rear bumper of a motor vehicle.

4. The system for providing visibility of oncoming vehicles and surrounding obstacles when passing, backing out of parking spaces/driveways, and entering/driving through intersections as claimed in claim 3 further comprises:
a lighting source; and
the lighting source being positioned adjacent to each of the pair of rear-facing cameras.

5. The system for providing visibility of oncoming vehicles and surrounding obstacles when passing, backing out of parking spaces/driveways, and entering/driving through intersections as claimed in claim 3 further comprises:
a wireless transceiver;
each of the pair of rear-facing cameras being communicably coupled with the wireless transceiver; and
the wireless transceiver being communicably coupled with the split viewing screen/monitor through the microcontroller.

6. The system for providing visibility of oncoming vehicles and surrounding obstacles when passing, backing out of parking spaces/driveways, and entering/driving through intersections as claimed in claim 1 further comprises:
a proximity sensor;
a visual indicator;
the proximity sensor being communicably coupled with the visual indicator through the microcontroller;
the visual indicator being mounted onto the split viewing screen/monitor; and
the proximity sensor being integrated into each of the pair of side mirror-mounted cameras.

7. The system for providing visibility of oncoming vehicles and surrounding obstacles when passing, backing out of parking spaces/driveways, and entering/driving through intersections as claimed in claim 1 further comprises:
an external rechargeable battery unit; and
the rechargeable battery unit being electrically connected to the pair of side mirror-mounted cameras, the microcontroller, and the split viewing screen/monitor.

8. The system for providing visibility of oncoming vehicles and surrounding obstacles when passing, backing out of parking spaces/driveways, and entering/driving through intersections as claimed in claim 1, wherein each of the pair of side-mirror mounted cameras is waterproof.

9. The system for providing visibility of oncoming vehicles and surrounding obstacles when passing, backing out of parking spaces/driveways, and entering/driving through intersections as claimed in claim 1, wherein each of the pair of side-mirror mounted cameras is shockproof.
